(19) United States
(12) Patent Application Publication
(10) Pub. No.: US 2012/0106202 A1
(43) Pub. Date: May 3, 2012

(54) LED LIGHT FIXTURE HAS OUTLETS AND REMOVABLE LED UNIT(S)

(76) Inventor: Tseng-Lu CHIEN, Walnut, CA (US)

(21) Appl. No.: 12/938,628

(22) Filed: Nov. 3, 2010

(51) Int. Cl. H01R 33/00

(52) U.S. Cl. 362/641

(57) ABSTRACT

The current invention related to the LED light which combined the UL listed and has its owned safety test certification of said power strips and removable LED unit(s) with prong means into a LED light to offer illumination to people. The LED unit(s) can remove from said LED light and connect with other outlet(s) to make its predetermined LED unit(s) function including regular LED light, LED power failure light, LED remote control light, LED emergency light, LED lamp holder, LED wireless light, LED whatever the LED light function available from market place. The power strips offer extra outlet(s) for people from the said LED light for under cabinet for kitchen, laundry room, Garage, storage room, closet with connect means to build desired length of LED light for big area with LED illumination and Extra Outlet(s).

This filing related to co-inventor's prior patent application Ser. No.

12-624,621, 12-622,100, 12-318,471, 12-318,470, 12-318,473,
12-292,153, 12-232,505, 12-232,035, 12-149,963, 12-149,964,
12-073,095, 12-073,889, 12-007,076, 12-003,691,
12-003,809,, 11-806,711, 11-806,285, 11-806,284, 11-566,322,
11-527,628, 11,527,629, 11-498,874, 12-545,992, 12-806,711,
12-806,285, 12-806,284, 12-566,322, 12-527,628, 12-527,629,
12-527,631, 12-502,661, 11-498,881, 11-255,981, 11-184,771,
11-152,063, 11-094,215, 11-092,742, 11-092,741, 11-094,156.
11-094,155. 10-954,189, 10-902,123, 10-883,719, 10-883,747,
10-341,519, 12-545,992, 12-292,580, 12-710,918, 12-622-000
12-710,561, 12-710, 12-711,456, 12-771,003

This is patent application related to co-inventor's prior filing Ser. No. 12/771,003 Filed on Apr. 30, 2010 for LED has plurality of project means

This is patent application related to co-inventor's prior filing Ser. No. 12/711,456 Filed on Feb. 25, 2010 for LED power failure Light

This is patent application related to co-inventor's prior filing Ser. No. 12/710,561 Filed on Feb.25, 2010 for LED light device has special effects

This is patent application related to co-inventor's prior filing Ser. No. 12/710,918 Filed on Feb. 25, 2010 for LED light device has more than 1 reflective means for plurality of image

This is patent application related to co-inventor's prior filing Ser. No. Nov. 24, 2009 file for the “ project device or assembly for variety of LED light”

This is patent application related to co-inventor's prior filing Ser. No. 12/622,000 Filed on Nov. 24, 2009 file for the “Interchangeable Universal Kits for all LED light”

This is patent application related to co-inventor's prior filing Ser. No. 12/318,471 Filed Dec. 30, 2008 file for the “LED night light with pinhole imaging”

This is patent application related to co-inventor's prior filing Ser. No. 12/318,470 Filed Dec. 24, 2008 file for the “LED night light with Projection features”

This is patent application related to co-inventor's prior filing Ser. No. 12/318,473 Filed Dec. 8, 2008 file for the “LED night light with laser or hologram element”

This is patent application related to co-inventor's prior filing Ser. No. 12/292,153 Filed Nov. 8, 2008 file for the “LED night light with Projection or imaging features”

This is patent application related to co-inventor's prior filing Ser. No. 12/232,505 Filed Sep. 16, 2008 file for the “LED night light with Projection features”

This is patent application related to co-inventor's prior filing Ser. No. 12/149,963 Filed on Apr. 21, 2008 file for the “Removable LED light device.

This is patent application related to co-inventor's prior filing Ser. No. 12/149,964 Filed on Apr. 21, 2008 file for the “Surface Mounted Device with LED light”.

This is patent application related to co-inventor's prior filing Ser. No. 12/073,095 Filed on Feb. 29, 2008 file for the “ LED Track light device.

This is patent application related to co-inventor's prior filing Ser. No. 12/073,889, filed on Feb. 12, 2008 file for the “LED light with changeable position with Preferable power source”.

This is patent application related to co-inventor's prior filing Ser. No. 12/007,076, filed on Jan. 7, 2008 file for the ” LED light with changeable geometric system”

This is patent application related to co-inventor's prior filing Ser. No. 12/003,691, filed on Dec. 31, 2007 file for the “LED light with changeable geometric dimension features”

This is patent application related to co-inventor's prior filing Ser. No. 12/003,809, filed on Jan 2, 2008 file for the “LED light with changeable features”

This is patent application related to co-inventor's prior filing Ser. No. 11/806,711 filed on Apr. 30, 2007 file for the “Multiple LED light with adjustable angle features”

This is patent application related to co-inventor's prior filing Ser. No. 11/806,285. LED Night light with outlet device filed on Apr. 30, 2007

This is patent application related to co-inventor's prior filing Ser. No. 11/806,284 LED Night light with more than 1 optics means filed on Apr. 28, 2007

This is patent application related to co-inventor's prior filing Ser. No. 11/527,628. Multiple function Night light with air fresher filed on Sep. 27, 2006.

This is patent application related to co-inventor's prior filing Ser. No. 11/527,629. LED Night light with interchangeable display unit filed on Sep. 27, 2006.

This is patent application related to co-inventor's prior filing Ser. No. 11/498,874. Area illumination Night light filed on Aug. 4, 2006.

This is patent application related to co-inventor's prior filing Ser. No. 11/527,631. LED Time piece night light filed on Sep. 27, 2006.

This is patent application related to co-inventor's prior filing Ser. No. 12/545,992 LED time piece Night light filed division of Ser. No. 11/527,631 on Aug. 24, 2009.

This is patent application related to co-inventor's prior filing Ser. No. 12/292,580 LED Time Piece Night light filed division of Ser. No. 11/527,631 on Aug. 24, 2009.

This is patent application related to co-inventor's prior filing Ser. No. 11/498,881, Poly Night light filed on Aug. 4, 2006.

This is patent application related to co-inventor's prior filing Ser. No. 11/255,981, Multiple light source Night Light filed on Oct. 24, 2005.

This is patent application related to co-inventor's prior filing Ser. No. 11/184,771 Light Device with EL elements filed on Oct. 11, 2005

This is patent application related to co-inventor's prior filing Ser. No. 11/1152,063 Outlet adaptor with EL filed on Jun. 5, 2005

This is patent application related to co-inventor's prior filing Ser. No.

This is patent application related to co-inventor's prior filing Ser. No. 11/094,215, filed Mar. 30, 2005 LED Night light with Liquid optics medium.

This is patent application related to co-inventor's prior filing Ser. No.11/092,741, filed Mar. 30, 2005 Night light with fiber optics.

This is patent application related to co-inventor's prior filing Ser. No. 10/883,747, filed Jul. 6, 2004 Fiber Optic light kits for footwear.

This is patent application related to co-inventor's prior filing Ser. No. 11/498,874, Area Illumination for LED night light

This is patent application related to co-inventor's prior filing Ser. No. 11/527,629. Time Piece with LED night light,

This is patent application related to co-inventor's prior filing Ser. No. 11/527,628. Multiple Function Night light with Air Freshener

This is patent application related to co-inventor's prior filing Ser. No. 11/806,284 LED Night light with more than one optics mediums

This is patent application related to co-inventor's prior filing Ser. No. 11/806,285 LED Night Light with multiple function

This is patent application related to co-inventor's prior filing Ser. No. 11/806,711 Multiple LEDs Light with adjustable angle function

Above listed prior filing case related apply physic optic theory to the said LED light for outdoor or indoor application powered by alternative current (hereafter as AC) or direct current (hereafter as DC) connect by the electric cored & its plug for outlet, or battery, or transformer, or solar, or other power source which same as current invention to apply the physics optics theory to create plurality of LED light beam to make illumination for the said close area(s), or remote-away distanced-area(s) by said project means which present to viewers which may further incorporate with same inventor's other features which may in any combination from the selection including more than 1 light source, more than 1 function, more than 1 optics means, more than 1 project means with super power saving circuit and cost saving concept.

### BACKGROUND

The current invention for any LED light fixture which has several LED unit(s) which not only can work for the said device power system but also has qualified safety requirement to be removable from the said device to plug into other outlet to offer the illumination for desired location where the said device location.

From market place there have many different LED light fixture for people to use at different location with desired function and light performance. The current invention related to the LED light fixture work for 120 Volt AC power source. But, All the said existing LED light fixture's LED unit(s) can not removable and plug into other outlets to make illumination.

The current invention the said LED light fixtures which has plurality of outlet(s) on the said fixture housing on x-y-z axis which also meet all safety requirement of the power strip or extension cord and pass UL or other laboratories testament with issued certification. In other words, the said current invention is combined the UL listed (Or other laboratories listed) power strips and outlet light unit(s) to form the said LED light fixtures.

(1) The current LED units can removable from fixture and work with any other outlet(s) device. one is from fixture's system, one is other outlet(s) device.

(2) The current LED units can removable from said device and carry to any outlet(s) device for illumination.

(3) The current LED units has its switch, sensor means. Remote control means, circuit means, control means to make the said LED units itself can be turn on and turn off under pre-determined function, brightness, color, time, period of time, duty, cycle, duration.

(4) The current LED units has its circuit means may incorporate with power saving IC or cost saving circuit as co-pending filing cases on February 2010 filed Ser. Nos. 12/624,000 or 12/624,621 for more than one power source (interchangeable power source) and cost saving design etc.

(5) The current LED units has prong means to connect the said device electric signal so can use device system to make the said LED unit for turn on or turn off under pre-determined function, brightness, color, time, period of time, duty, cycle, duration.

(6) The current LED unit incorporate more than one power sources including fixture's system power source and other outlet's power source which same as co-pending filing for “interchangeable power source” concept such as Ser. Nos. 12/622,000, 12/624,621 and its prior filing cases.

(7) The current LED unit incorporate charging circuit to allow the LED units can be recharging the energy storage means to make the said LED unit as emergency light or other function LED light unit, or use non-rechargeable circuit has its power source such as batteries or energy storage means to has its power source from adaptor, transformer, solar cells, wind power, generator, chemical power source etc but both types still has basic LED light unit function which will turn on and turn off LED light while the prong means plug into the said any outlet device.

(8) The current fixture's system power source and LED unit power source at least has one power source and 2^{nd} power source which may selected from group combination from 120 Volt Alternative current source, Direct current source, transformer source, adaptor source, solar power related source, wind power related source, chemical related source, energy storage means source or conventional available power sources available from market place.

(9) The current fixture's system may incorporated multiple function including light fixture, power fail light, motion sensor, photo sensor, emergency light, flash light to make removable LED unit can be turn on or turn off under predetermined function to offer the illumination under all kind of condition such as earth quake, power fail, flood, fire and any other incidents or un-expected hazards caused by people or environment.

(10) The current fixture will become a power strip or extension cord while removed all the said LED unit(s) from the said LED light fixture for people to use such as under cabinet light in kitchen for certain number of LED unit(s) illumination with certain number of outlet(s) can connect with any other electric devices while needed.

The current invention had made big (10) improvements as above discussed and also cover the co-pending filing case's some extra features as below listed (A) to (M):
A. The LED light device as parent case of continuously filing case of “ LED light has more than 1 optics means” Ser. No. 11/806,284, the said 1^{st} LED elements incorporated with optics medium to make the said LED, LEDs to have good photometric of area light illumination to act as night light.
B. The LED light device as parent case of continuously filing of “LED light has Multiple light source” Ser. No. 11/255,981, the said the 1^{st} and 2^{nd} LED elements are arranged in a matrix shape face at least one or multiple directions, position, orientation, locations to be seen by viewers, some LED or LEDs act for night light and some LED or LEDs act for emergency light.
C. The LED light device as parent case of continuously filing of “LED light has Multiple light source” Ser. No. 11/255,981, the said the 1^{st} and 2^{nd} LED elements has plurality of LED or LEDs to face more than 1 directions, locations, position, orientations to offer multiple areas has illuminations.
D. The LED light device, the said switch is one of mechanical or electric switch has at least one of the function selected from On, Off, Auto, Timer, Time delay, Flashing, Partial On, Partial Off, Partial flash, Partial Chasing, Partial random, Partial fade-in and fade-out, duration of ON and OFF of each blinking function, power saving selection, blinking function selection, persistence of vision device, blinking of LED or LEDs, On and OFF % of each blinking cycle, Power saving setting or selections, LED or LEDs group reset selections or any LED light functions for plurality of LEDs available from market place.
E. The LED light device as parent filing case as above listed including Ser. No. 11/806,285, LED means can be any type of LED specification with single color or multiple colors, and all said LEDs can change color, number of LEDs for illumination, light functions by control, switch, sensor means.
F. The LED light device as co-pending filing “Multiple function LED light” Ser. No. 11/806,285 as parent filing of continuously in Part case, the said LED means can incorporated other functions selected from group of add functions including outlet, air fresher, motion sensor, beacon light, warning light, chasing lights, flash light, bug repelled device, mosquito repelled device, mouse repelled device, sonic repelled device, project device, persistence of vision device blinking of LED or LEDs, On and OFF % of each blinking cycle, Power saving setting or selections, LED or LEDs group reset selections for extra functions on the device.
G. The LED light device as co-pending filing of parent case of continuously in part filing case of “LED light has multiple light source Ser. No. 11/255,981, the said device has other LED or LEDs for indicated the battery status including low battery capacity or full capacity or half capacity with preferred colors indicate the status of batteries, or show the device on duty status.
H. The LED light device as co-pending filing ” LED device has special effects” filed on Feb. 25, 2010 as continuously In parts filing and parent continuity case, the LED means have blinking flashing which has more than people eye response time within 1/24 to 1/16 second to make the illusion based on inertia of a human eye, or the blinking speed is meet requirement of persistence of vision to let the people see the continuously light beam from LED element(s) to save the power consumption of the said batteries.
I. The LED light device co-pending filing “ LED device has special effects” filed on Feb. 25, 2010 as continuously In parts filing and parent continuity case, the said blinking frequency will quickly than the human eye's scan speed which within 1/48 second so the frequency quickly than 48 HZ, Or blinking of LED or LEDs, On and OFF % of each blinking cycle, Power saving setting or selections, LED or LEDs group reset selections
J. The LED light device, the said battery has voltage higher than LED trigger voltage, or the battery has voltage lower than LED trigger voltage while incorporate with the voltage raise-up electric circuit such as chock or others equivalent function electric circuit to raise the battery voltage up to the LED trigger voltage.
K. The LED light device has power saving features incorporate with co-pending parent filing features.

At least one of LED or LEDs for light source.

At least one housing has space to install related preferred means which in desire combination select from circuit means, conductive means, electric components parts and accessories, switch means, sensor means, integrated circuit (IC), micro controller to connect with conventional market available power source to make the said LED or LEDs turn on and turn off under predetermined function, effects, On/Off on certain % duration, cycles, color, brightness.

The said Power Saving features made by control means to make the LED or LEDs turn-on and turn-off duration time on certain percentage of the each cycle. The said cycle means each second has certain times for turn-on and turn-off. The cycles number meet the persistence of vision of human eye which more quickly than the human eyes response time within 1/24 to 1/16 second so can make people see the blinking LED or LEDs look as continuously on status.
L. The LED light device has cost saving features consist of;

At least one of LED or LEDs for light source.

At least one housing has space to install related preferred means which in desire combination select from circuit means, conductive means, electric components parts and accessories, switch means, sensor means, integrated circuit (IC), micro controller to connect with conventional market available power source to make the said LED or LEDs turn on and turn off under predetermined function, effects, On/Off on certain % duration, cycles, color, brightness.

The said Power source preferred is batteries.

The said cost saving made by said batteries which has total batteries' voltage is less than the LED or LEDs trigger voltage and use voltage raise-up electric components and related parts and accessories to make lower batteries' voltage raise-up to over the LED or LEDs trigger voltage to make the said LED or LEDs to turn on and turn off under predetermined function, effects, On/Off on certain % duration, cycles, color, brightness.

Hereafter, Please check the details drawing for the current invention as below:
M: The co-pending filing for LED light with interchangeable power source which can has preferred 120 Volt power source and it also can change to the batteries power source including the parent filing on the U.S. Ser. Nos. 12/232,505, 12/292,153, 12/318,473, 12/318,470. 12/318,471 and 12/622,000. All these parent filing disclosure the interchangeable power source from one power source to other power source for said LED light.

All these (A) to (M) as parent filing of current filing case so the current invention should fall within all these parent filing cases claims too.

### DRAWING

FIG. 1 : Disclosure the 1^{st} preferred embodiment of current invention of LED unit(s) which is pass all safety requirement and has laboratory issued certification can sell individually at market place. The brightness and function as any one of conventional available said LED light.

FIG. 2 and FIG. 3 and FIG. 4 : Disclosure the 1^{st} preferred embodiment of current invention of the LED light fixtures which is special design power strips or extension cord which is pass all safety requirement and has laboratory issued certification can sell individually at market place. The specification and function including surge protection, overload current warning system or any other related functions may be same as any one of conventional market available models. The power strips also can connect with other power strips for desired number of power strips or fixtures.

FIG. 5a, FIG. 5b, FIG. 5c: Disclosure the all viewing angle of the FIG. 2 and FIG. 3 and FIG. 4 and its alternative design.

FIG. 5a: Disclosure the 3 UL listed LED light unit(s) are arranged on the UL listed 5 outlet(s) power strips to become a LED light fixture. The 2 outlet(s) do not have LED light unit(s) are for the spare outlet(s) for house lady to connect for other electric device while use fixture for kitchen under cabinet or laundry room or garage, storage room etc.

FIG. 5b: show the all LED light unit(s) are removed from LED light fixture so show out (5) outlets for people to use while need to have extra outlet(s) to help them to work out some special things.

FIG. 5c: disclosure the back side narrow width attachments means to allow the attachment means can fit and install on most marrow bar, rib, tube, frame of the said cabinet. Some wider attachment means can not fit because too wide so wider than the bar, rib, tube, frame of cabinet to make very bad installation.

From FIG. 6a and FIG. 6b and FIG. 7a and FIG. 7b and FIG. 8a and FIG. 8b″ Disclosure the two of preferred design with different shape and function of the LED unit(s) on the different outlet power strips.

From FIG. 9: Disclosure the transform shape of power strips which fall within the co-pending filing case Ser. No. 12/232,035 filed date Jun. 18, 2008 which are allowance at this time. The two arms of power strips can be change orientation and position while force applied to the arms. So can change the shape from the rectangular to linear type of the power strips. It also appreciated the each outlet receiving unit(s) can be rotating to desired orientation as drawing shown.

From FIG. 10: Disclosure the co-pending case Ser. No. 12/232,035 drawings to support the FIG. 9 as prior related filing case.

### DETAIL DESCRIPTION

The current invention for all kind of said conventional LED light fixture which has the at least one of LED unit(s) has prong means to make the predetermined light performance including regular illumination, power fail light, motion sensor light, remote control light, spot light, garden light, emergency light, floor light, flash light, desk lamp, table lamp or any other conventional available Led light but with prong means.

The said any kind of conventional LED light has the LED unit(s) which has its preferred power source(s) and its function design to make illumination after the said LED Unit(s) are removed from the said LED light fixture while the prong means insert into outlet device. Hence, offer a very practically additional function to consumer and make the said LED light fixtures become a valuable device.

It also offer the extra outlet(s) to people of convention LED light fixture. This is not shown on all prior arts.

The Said LED light and LED Unit(s) may incorporated same power source or different power source (120 Volt AC, 110 Volt AC, or 220 Volt AC, or 250 Volt AC for different countries or with build in other power source(s)) which depend on the market requirement. The said LED light Fixtures has outlet(s) receiving means to allow the LED unit(s)'s prong means can fit within which may including ground prong to make LED unit(s) can solid to fit within the said LED light fixture. Furthermore, the current invention have very safety consideration that people will not touch the electric carry parts of the outlet receiving means of LED light fixtures while the said LED unit(s) are removed from the said outlet receiving means. Any electric carry parts of the compartment will meet the safety regulation and prevent from people to touch and make electric shock.

The current invention is different with co-pending filing for the Interchangeable power source LED light as co-pending filing for LED light with interchangeable power source which can has preferred 120 Volt power source and it also can change to the batteries power source including the parent filing on the U.S. Ser. Nos. 12/232,505, 12/292,153, 12/318,473, 12/318,470, 12/318,471 and 12/622,000. All these related filing disclosure the interchangeable power source from one power source to other power source for said LED unit(s). The current invention is not interchangeable from one to other one power source. The current invention is LED unit(s) can work with any outlet device which may has more than one power source one is other build-in power source and one is power source from prong means which has similar electric signals to trigger the said LED unit(s) to perform the desired function(s) by inner circuit means.

The current invention is the said LED unit(s) has prong means to work with prong power source and while it removed from the said LED light fixture it still will use the prong means electric system as basic power source. If the said LED unit(s) is one of power failure LED unit or emergency light LED unit it may have other than prong means power source build inside the LED unit(s).

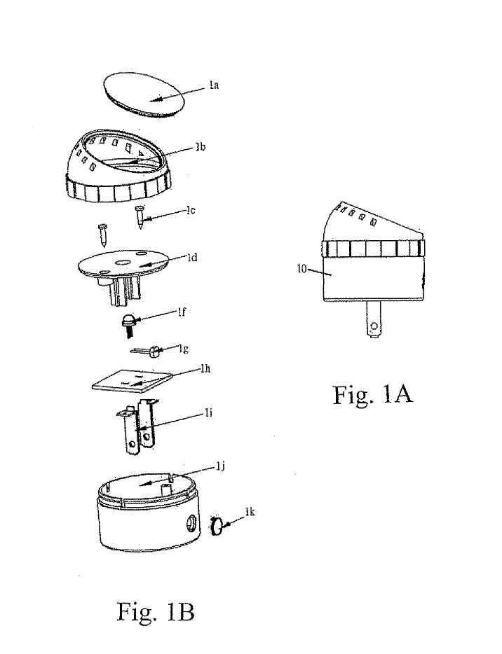

From FIG. 1, Show the UL listed and has UL issued safety certification LED light unit(s) (10) has the base (1j) with prong means (1i) and circuit means (1h) and sensor means (1g) and LED (1g) to well arranged inside the base (1j). The middle divider (1d) has hole on center to allow LED (1f) to show out and emit the light beams to the inner side of the top cover (1b) and allow the light beam be seen though lens (1a).

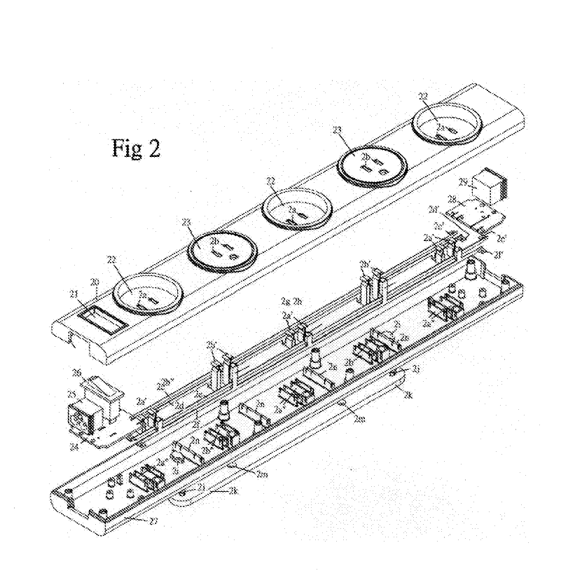

From FIG. 2, show the UL listed and has UL issued safety certification Power strips which has 5 outlet receiving means some is on lower location (22) and some is recess (23) on the power strips. The lower location outlet(s) (22) mainly design for cosmetic consideration to make the LED unit(s) can fit within as LED light fixtures. If make all these lower position for recess which will be very bad value for appearance. The power strip (20) has switch means (21) or other circuit means (24) to make the said power strips same as any other conventional market available power strips with special functions such as surge protection, on/off switch, remote control on/Off, motion sensor on/Off for power to power strips etc. Any function of power strips still fall within the current invention scope and we do not discuss more at this moment.

The Power strip (20) has connect means (24) on one end and other connector means (29) on other end to allow the said Power strips can connect from 1 to N (Any number) so can allow the people to make desired length of the LED light fixture with removable LED light unit(s) and desired power strips with desired outlet(s) can use. The current invention preferred to has 60% of outlet(s) number has removable LED light unit(s) and 40% of outlet(s) number has no LED light unit(s) so people know they are not only buy the single function LED light fixture but also buy a power strips for FREE. This big improvement will let people save money to buy individual LED light fixture or individual power strips. Normally, the kitchen area has not sufficient outlet receiving unit(s) for house ladies to connect with juicy machine, toaster machine, coffee machine, rice cooking machine, can opener machine, micro oven machine so the current invention to combine the power strips with removable LED unit(s) with prong means will be big help to all house ladies.

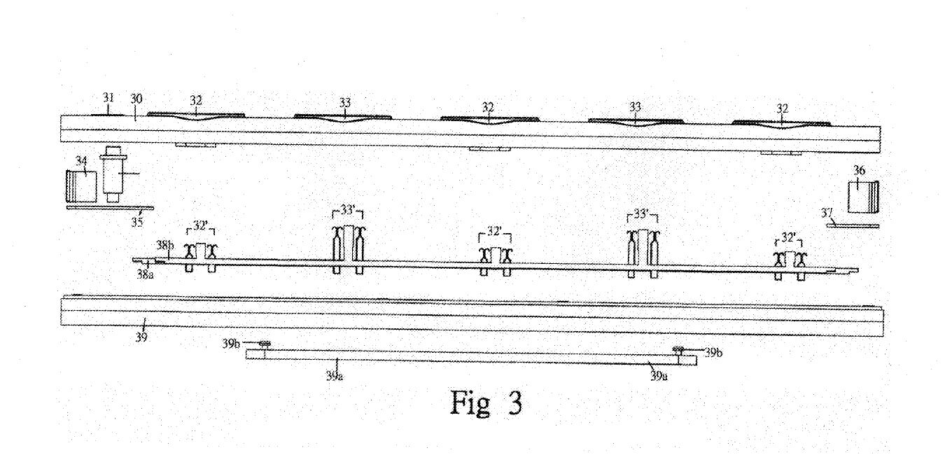

From FIG. 3, show the details construction of the power strips with high and low metal conductive means (32′) (33′) to make the special design for power strips incorporated LED unit(s) has prong means.

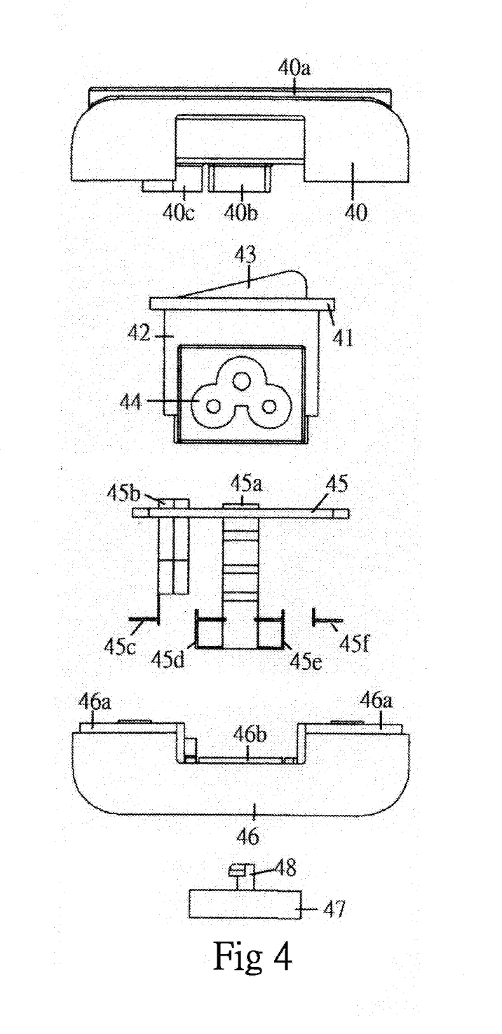

From FIG. 4, show the end view for the current invention for connect means on end and its details.

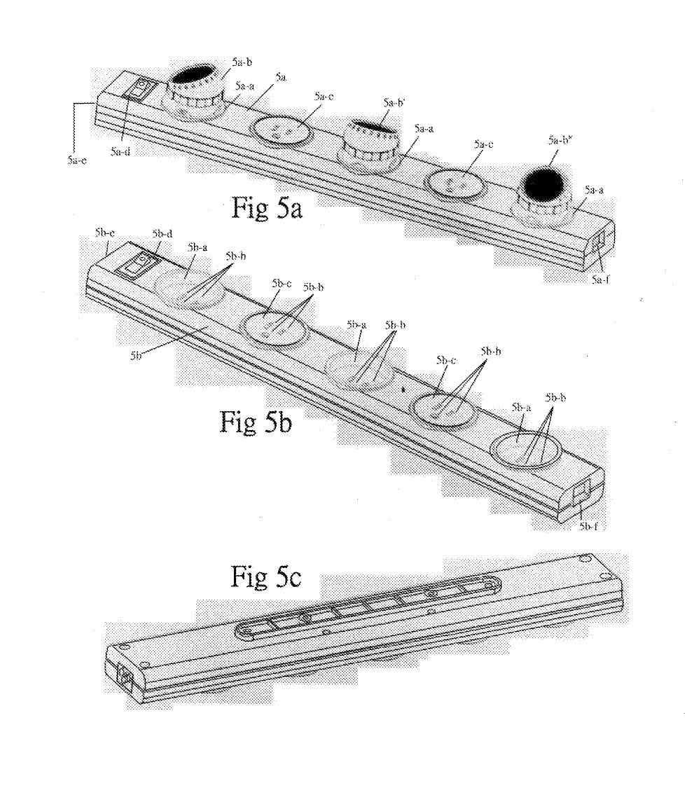

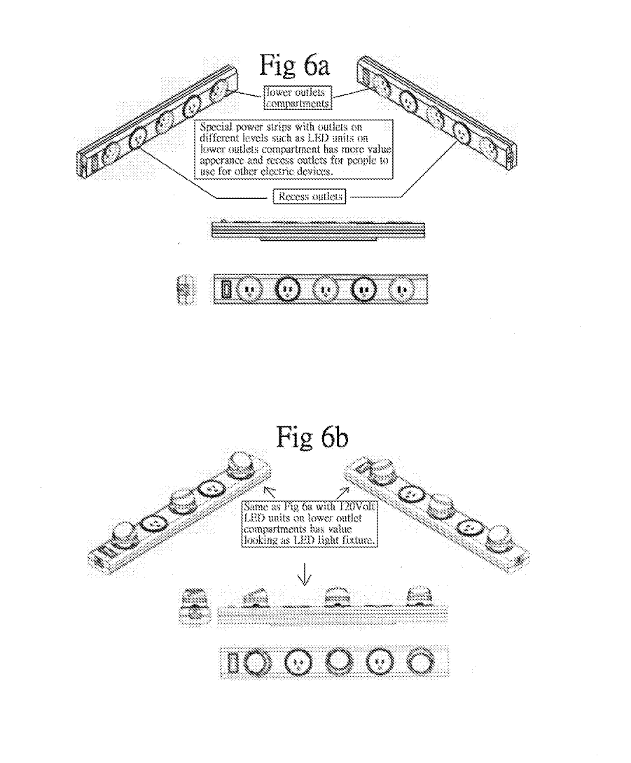

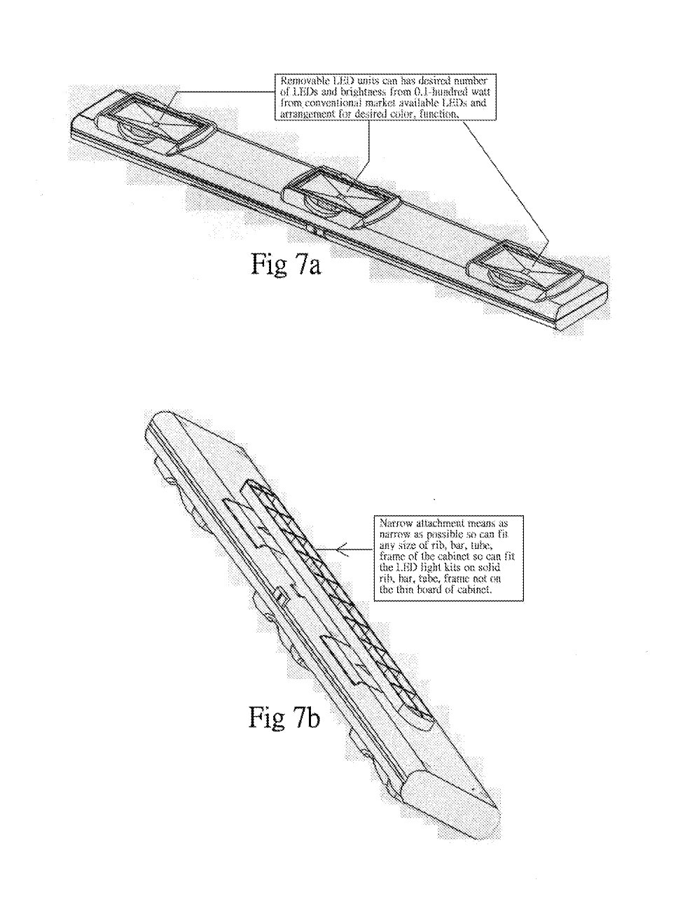

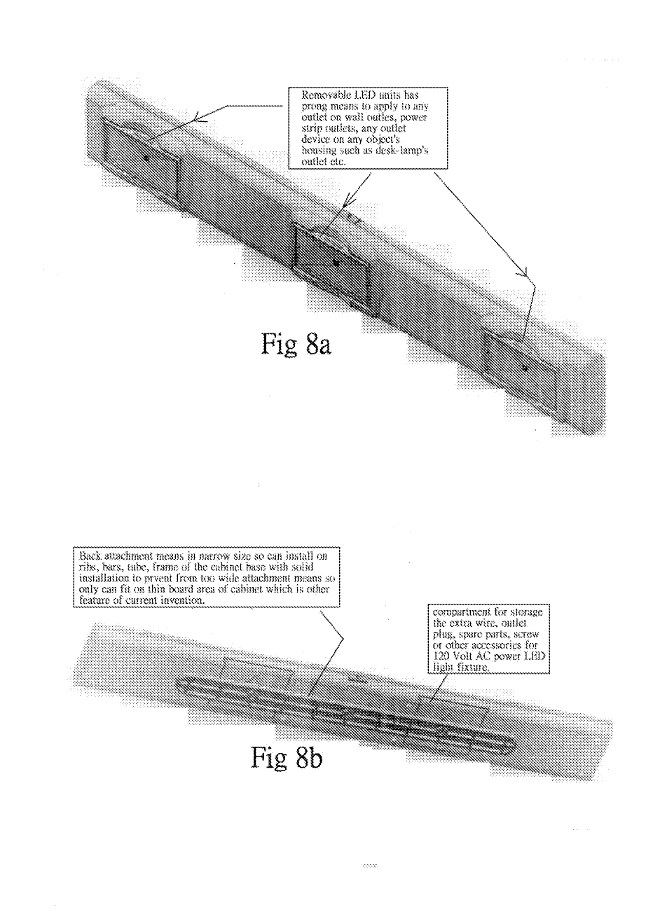

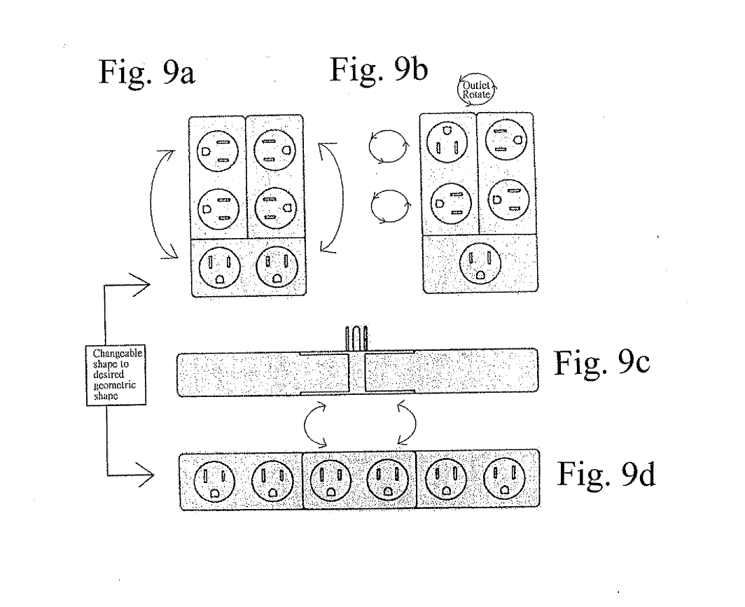

From FIG. 5a to FIG. 5c show below:

FIG. 5a: Disclosure the 3 UL listed LED light unit(s) (5a-b) (5a-b′) (5a-b″) are arranged on the UL listed 5 outlet(s) power strips (5a) to become a LED light fixture. The 2 outlet(s) (5a-c) (5a-c) do not have LED light unit(s) are for the spare outlet(s) for house lady to connect for other electric device while use fixture for kitchen under cabinet or laundry room or garage, storage room etc.

FIG. 5b: show the all LED light unit(s) are removed from LED light fixture so show out (5) outlets receiving means (5b-a) (5b-c) (for people to use while need to have extra outlet(s) to help them to work out some special things.

FIG. 5c: disclosure the back side narrow width attachments means to allow the attachment means can fit and install on most marrow bar, rib, tube, frame of the said cabinet. Some wider attachment means can not fit because too wide so wider than the bar, rib, tube, frame of cabinet to make very bad installation.

From FIG. 6a and FIG. 6b and FIG. 7a and FIG. 7b and FIG. 8a and FIG. 8b″ Disclosure the two of preferred design with different shape and function of the LED unit(s) on the different outlet power strips. The details notes shown on the each drawing for details.

From FIG. 9: Disclosure the transform shape of power strips which fall within the co-pending filing case Ser. No. 12/232,035 filed date Jun. 18, 2008 which are allowance at this time. The two arms of power strips can be change orientation and position while force applied to the arms. So can change the shape from the rectangular to linear type of the power strips. It also appreciated the each outlet receiving unit(s) can be rotating to desired orientation as drawing shown. The details notes shown on drawings.

From FIG. 10: Disclosure the co-pending case Ser. No. 12/232,035 drawings to support the FIG. 9 as prior related filing case.

1. LED light has outlet(s) and removable LED unit(s) consist of;
At least one LED light which has its geometric shape and construction to make at least one of LED unit(s) to offer illumination to certain areas has at least one function or other added functions which selected from group combination including regular illumination light, light, reading light, night light, light fixture, motion sensor light, power fail light, photo sensing light, dimmable light, spot light, remote control light, wireless control light, car light, vehicle light, boat light, aircraft light, all different purpose LED light.
The said LED unit(s) is removable from the said light and has its prong means to make the LED unit(s) to turn on and turn off under predetermined function, brightness, color, time, period of time, duty, cycle, duration while prong means connect with outlet(s).
The said LED unit(s) can work under the more than one power source including power source of the said LED light from prong means and power source of which build-inside the LED unit(s).
The said power source for said LED light powered by AC power source. The said LED unit(s) are powered by at least one power source from prong means or can added build-in Power source which select from group combination from 120 Volt alternative current, batteries, or LED unit(s) to offer preferable illumination.
The said LED light or LED units incorporate the desired electric parts and accessories selected from group combination from power saving IC, cost saving circuit, circuit, Integrated Circuit (I.C.), sensor, switch, contact means, conductive means, electric components to make the LED or LED unit(s) can have predetermined performance.
The improvement including;
The said LED light has its predesigned function, performance to offer illumination and its LED unit(s) can be removable away from the said LED light.
The said LED unit(s) has prong means to connect with power source may rechargeable or non-rechargeable while connect with the said LED light.
The function, performance of said the LED unit(s) is same or different from the said LED light because LED light has its original designed function, performance.
The said LED light device may in any kind of conventional LED light device's function which available from market place.
The said LED unit(s) can allow people to removable from the said LED light and carry to anywhere to make desired area(s) for illumination while the said LED unit(s) prong means connect with outlet device.
The said LED unit(s) and power strips both have its own safety testament certification issued by test laboratories.

2. The LED light has outlet(s) and removable LED unit(s) consist of;
At least one LED unit(s) has passed all safety requirement and has its test certification issued by laboratories.
At least one power strips has passed all safety requirement and has its test certification issued by laboratories.
The said LED light are combined the said at least one of power strips and at least one of the said removable LED unit(s) with prong means to become a LED light to offer illumination.
The said LED unit(s) has prong means which can make illumination while connect with said LED light outlet(s) or any other outlet(s) which not located on the said LED light.
